(19) United States
(12) Patent Application Publication
(10) Pub. No.: US 2014/0214804 A1
(43) Pub. Date: Jul. 31, 2014

(54) METHODS, APPARATUS AND SYSTEM FOR A MULTI-RESOLUTION VISUAL CROSSTAB

(71) Applicant: Qiang Han, Vancouver (CA)

(72) Inventor: Qiang Han, Vancouver (CA)

(73) Assignee: Business Objects Software Ltd., Dublin (IE)

(21) Appl. No.: 13/755,968

(22) Filed: Jan. 31, 2013

(51) Int. Cl. G06F 17/30

(52) U.S. Cl. CPC G06F 17/30554
USPC 707/722

(57) ABSTRACT

Methods, systems, and computer program products for visually representing and displaying data are described. One or more cells may be selected from a plurality of displayed cells in a crosstab, wherein the subset of cells has a context defined at least by one or more rows and one or more columns. An effect may be selected to apply on the subset of cells, wherein the effect includes an embedded query including parameters drawn from context of the subset of cells. A selected effect on a subset of the plurality of displayed cells may be applied. Effects may include lens effects, brush effects, and box-in/box-out effects.

### FIELD

The present disclosure relates to displaying information. In an example embodiment, the disclosure relates to visually representing and displaying data.

### BACKGROUND

Cross tabulation, also known as crosstab, is a process for tabulating data to create summary results based on two or more data variables. The underlying data may reside in a database and/or may be modeled using a plurality of dimensions. The summary result may be presented in a visualization called a cross table; this is also known as a crosstab. A crosstab comprising cells, or data points, arranged in an array of rows and columns. The table may be generated and manipulated using queries to filter and summarize the data. The crosstab interface comprises dimensional and measure elements that may be selected by a user to view different summaries of the underlying data.

Crosstab and Visual Crosstab are applications used as a principle interface for data analysis based on cross tabulation. Crosstab and Visual Crosstab enable users to express analytic needs through a structural query paradigm based on columns, rows, and data regions.

In analyzing data, users may search for recurring patterns (e.g., clustering and the like), trends, and correlations using crosstabs. The underlying data may be represented using one or more measures and one or more dimensions. As the amount of data increases, the potential for data patterns to be hidden may increase. For example, viewing a summary of sales information over a period of twenty years may obscure data patterns that would be apparent in viewing sales information over a period of one year. Similarly, as the number of dimensions increases, the data may become more difficult to visualize.

### BRIEF DESCRIPTION OF DRAWINGS

The present disclosure is illustrated by way of example and not limitation in the figures of the accompanying drawings, in which like references indicate similar elements and in which:

FIG. 1 is an example data visualization of a crosstab comprising an array of cells based on an example underlying data configuration of 100 million rows and 100 columns, in accordance with one example embodiment;

FIG. 2 is an example bar chart representing the sales of eight different categories of products in each of four different quarters, in accordance with one example embodiment;

FIG. 3 is an example data visualization of a crosstab comprising an array of cells based on an example underlying data configuration of 100 million rows and 100 columns, in accordance with one example embodiment;

FIG. 4 is an example scatter plot chart where each color of the scatter plot represents sales for a particular country, in accordance with one example embodiment;

FIG. 5 illustrates the example crosstab of FIG. 3 where a cell has been replaced with a scatter plot chart, in accordance with one example embodiment;

FIG. 6 shows an application of a box-in effect to the example crosstab of FIG. 3, in accordance with one example embodiment;

FIG. 7 is an example flowchart for applying a lens effect, a brush effect and/or a box-in/box-out effect to one or more cells of a crosstab, in accordance with one example embodiment;

FIG. 8 is a block diagram of an apparatus, in accordance with an example embodiment, for visually displaying data; and

FIG. 9 is a block diagram of a computer processing system within which a set of instructions, for causing the computer to perform any one or more of the methodologies discussed herein, may be executed.

### DETAILED DESCRIPTION

The description that follows includes illustrative systems, methods, techniques, instruction sequences, and computing program products that embody example embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures and techniques have not been shown in detail.

Generally, methods, systems, and computer program products for visually displaying data are described. The visually displayed data may assist a user in interpreting a data space that may be difficult to view due to human perceptual limitations, and limited human domain knowledge. In one example embodiment, plots, graphs, and/or charts may be displayed in place of numeric values in the cells of a crosstab. The disclosed crosstab techniques may be combined with concepts including, but not limited to, visual analytics, faceting, and/or incremental analysis to assist in identifying visually hidden data patterns.

In analyzing data, users may search for recurring patterns (e.g., clustering), trending, and correlations. The underlying data may be represented using one or more measures and one or more dimensions. As the amount of data increases, the potential for hidden data patterns may increase. For example, viewing sales information, over a period of twenty years may obscure more data patterns than viewing sales information over a period of one year. Similarly, as the number of dimensions increases, the data may become more difficult to visualize.

By selecting the appropriate combination of attributes, for example, hidden data patterns may be visualized and exposed. An example of a potentially hidden data pattern is a shift in buying behavior that slowly occurs over an extended time period, e.g., ten years. Cumulative sales data for the ten year period may suppress a data pattern showing strong sales in the early years and weak sales in the latter years. Visualizing the underlying data may expose the shift in buying behavior.

In one example embodiment, a multi-resolution visual crosstab (MVC) technique may be used to enable the rendering of data at different resolutions. In one example embodiment, MVC may display numeric values in the cells of the crosstab. In one example embodiment, MVC may insert tabular data, plots, graphs, and/or charts within one or more cells of the crosstab to provide additional information on the corresponding data point(s). In one example embodiment, MVC includes one or more of the following techniques: “point expansion,” “lens effect,” “brush effect,” and “box-in/box-out” exploration,

### Example Crosstab Visualization

In one example embodiment, an underlying data configuration may comprise 100 million rows and 100 columns. Each row may correspond to a particular period of time (e.g., one day), each column may correspond to a particular type of product (e.g., milk), and each data point may represent the sales of the corresponding type of product during the corresponding period of time. The 100 million rows of data may therefore correspond to an extended time period. For example, the 100 million rows of data may correspond to sales data for a period of greater than twenty years.

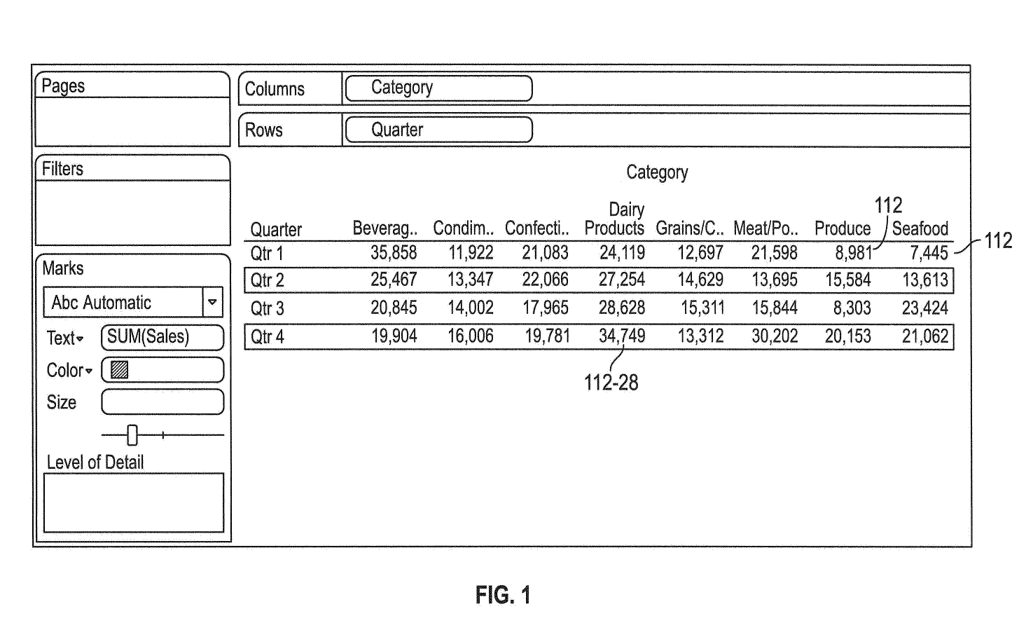

FIG. 1 is an example data visualization of a crosstab comprising an array of cells 112 based on an example underlying data configuration of 100 million rows and 100 columns, in accordance with one example embodiment. In the example of FIG. 1, the columns may correspond to various attributes. For example, each column may correspond to a category of products, where each category represents one or more types of products of the underlying data configuration. For example, the product types of soda, milk, water, and the like may correspond to the category “beverages”.

Each row of FIG. 1 may correspond to a period of time. For example, each row may correspond to a quarter (three month time period) thereby representing a number of consecutive days of the underlying data configuration. Each data point may therefore represent the number of items of the corresponding category of product sold during the corresponding time period. In some embodiments, the intersection of a row and a column defines a context for a cell at that intersection based on the attributes of the corresponding row and column.

In the example crosstab of FIG. 1, a query has been performed for a summation of sales where the columns are selected to represent categories of products and the rows are selected to represent periods of time (quarters 1 through 4). Each cell 112 represents the number of items of the corresponding product category sold during the corresponding time period. For example, cell 112-28 indicates that 34,749 dairy products were sold in quarter 4. In the underlying data configuration, dairy products may include, for example, milk, cream, butter, and ice cream, and the sales of each product may be recorded, for example, on a daily basis. In one example embodiment, the value of 34,749 may equal a total sum of: 1) the daily sales of milk during the fourth quarter of a single year, 2) the daily sales of cream during the fourth quarter of a single year, 3) the daily sales of butter during the fourth quarter of a single year, and 4) the daily sales of ice cream during the fourth quarter of a single year. In one example embodiment, the value of 34,749 is a total sum of: 1) the daily sales of milk during the fourth quarter of each of a plurality of years, 2 the daily sales of cream during the fourth quarter of each of a plurality of years, 3) the daily sales of butter during the fourth quarter of each of a plurality of years, and 4) the daily sales of ice cream during the fourth quarter of each of a plurality of years. The example crosstab of FIG. 1 is then a coarse array of contexts. In some embodiments, the combination of a row, a column, and a measure define a context for a cell.

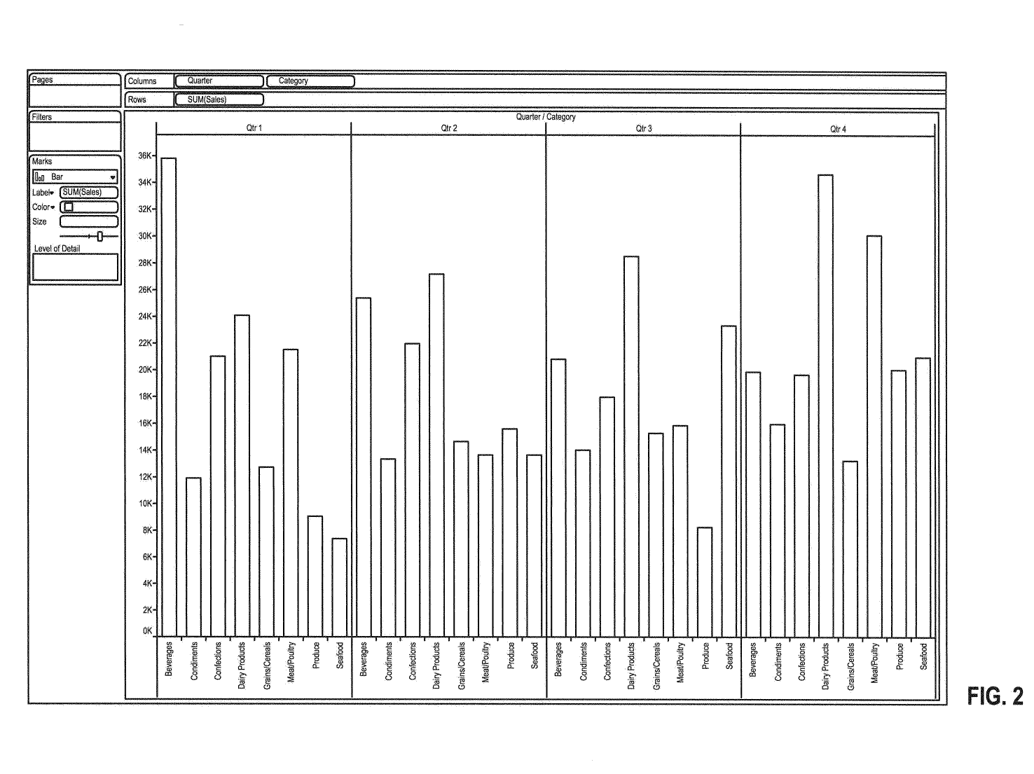

In one example embodiment, a user may render the data points of FIG. 1 as a bar chart. A user may use the bar chart to compare sales data by category across a plurality of quarters. FIG. 2 is an example bar chart representing the sales of eight different categories of products for each of four different quarters, in accordance with one example embodiment. Each bar may represent the sales for a category of product in a corresponding quarter of a single year, or may represent the cumulative sales for a category of product in a corresponding quarter of a plurality of years. The bar chart of FIG. 2 may provide for a comparison of sales data across different quarters, by category. The details of the data may be suppressed, however. For example, if a bar represents the cumulative sales for a category of product in a corresponding quarter for a plurality of years, the data corresponding to the sales in a particular year may be suppressed. In addition, underlying data that represents sales across different countries, cities and/or shops may not be visible.

### Point Expansion

In one example embodiment, point expansion is a technique where a data point in a crosstab that may be based on suppressed dimensions and/or measures may be expanded to expose some or all of the underlying data. For example, the data point “total sales of the eastern region for the year 2011” may be expanded along a time dimension to expose underlying data based on quarters (three month time periods). In another example, the data point “total sales of the eastern region for the year 2011” may be expanded on a “hidden” dimension. For example, the total sales data point may not expose the sales per product category (a “hidden” dimension). The data point may be expanded to expose the “product category” dimension. In another example, the data point “total sales of the eastern region for the year 2011” may be expanded on a “hidden” measure. For example, the total sales data point may not expose a profit measure (a “hidden” measure). The data point may be expanded to expose the “profit” measure.

### Lens and Brush Effects

In one example embodiment, a data point may be expanded using a lens or brush effect applied to one or more cells of the crosstab. The lens and brush effects are essentially mechanisms that apply various expansion algorithms to a selected data point(s) or cell(s) of a crosstab. In one example embodiment, a lens or brush is applied to a data point and its suppressed records. The lens and brush effects may expose a hidden dimension, may expose a hidden measure, and/or may expand along a dimension. A lens effect may be applied to a single cell. A brush effect is the substantially simultaneous application of a lens effect to a plurality of cells. For example, if a data point represents the total sales for a category of product for a defined period of time and a user is interested in the trend of total sales for the category product over time, a lens effect may be applied to the associated data point, and a trend line may be generated and displayed. In another example embodiment, if the underlying data for a data point comprises the total sales of a variety of products spanning an extended time period and a large number of records, a statistics lens or statistics brush effect may be applied. For example, k-mean clustering, on a dimension such as shops, seasons, and the like may be generated and displayed.

In one example embodiment, an application of a lens or brush effect may generate a plot, graph or chart that exposes suppressed data, and the numeric value of the corresponding cell may be replaced with the generated plot, graph or chart. In one example embodiment, an application of a lens or brush effect may generate tabular data that exposes suppressed data, and the numeric value of the corresponding cell may be replaced with the tabular data.

In one example embodiment, users may be allowed to apply a brush effect to a data point one or more times. For example, the lens or brush effect can be sequentially applied to a data point (known as chaining). In one example, a lens effect may be applied to a selected data point to expose a hidden dimension. If the hidden dimension is of further interest to the user, the lens effect may then be applied to the remaining data points to create a new query. If desired, another lens effect may be applied to the selected data point.

The lens and brush effects may enable one or more different expansion techniques to be independently applied to one or more different data points or cells of a crosstab. In one example embodiment, one type of lens effect may be applied to one cell of the crosstab and another type of lens effect may be substantially simultaneously applied to another cell of the crosstab. For example, a “scatter plot” lens effect may be applied to one cell of the crosstab to expose an additional measure and a hidden dimension, and a “trend line” lens effect may be applied to one cell of the crosstab to show, for example, the trend of an exposed measure for an extended period of time. The application of the cited lens effects to different cells is known as lens effects with discriminations.

In one example embodiment, the application of the lens or brush effect may be with one or more conditions. For example, if the count of suppressed rows is greater than or equal to one minion, a condition may specify that a statistics lens on sampling be applied by default.

In one example embodiment, a data point expansion algorithm may be based on one or more of the following categories of lens effects:

1) Query lens effect: a dimension and/or measure selection technique, e.g., a crosstab within a crosstab, to enable the viewing of another level of suppressed data; and

2) Statistics lens effect: a sampling technique, such as random sampling at a regular interval for a selected dimension (e.g., time), that is beneficial for pattern recognition.

Box-In/Box-Out Exploration

The application of a lens and/or brush effect may “paint a box” and expose suppressed data defined by one or more combinations of one or more dimensions and one or more measures. In one example embodiment, a user may apply a lens or brush effect to expose a hidden dimension(s) and/or measure(s). Based on the newly exposed data, the user may identify a potential data pattern in the effected data point and may be interested in generating a modified query based on the addition of the hidden dimension(s) and/or measure(s) to the current query.

In one example embodiment, the added dimension(s) and/or measure(s) may be applied to all cells of the crosstab via box-in/box-out exploration. The box-in effect may allow a user to specify one or more dimensions and/or measures that are added to the query and therefore applied to all cells of the crosstab. The effect is to allow a user to “drill down” a level in the suppressed data with the displayed box of the crosstab indicating the “drill down” level. For example, a selection of a product category as a column, a selection of a region as a row, and a selection of a sum(sale) as a data region may be used to generate an initial crosstab. In the initial crosstab, the displayed data points may, for example, represent an aggregation of sales for a ten-year period. A user may choose to apply a query brush to “drill down” and generate a trend line for a number of cells in the crosstab (for example, by adding “time” as a row and “product” as a column to the crosstab). If a user is interested in the resulting trend line, the row of “time” and/or column of “product” may be applied to the other cells of the crosstab via the box-in effect. As a result, the query may be modified to include the added dimension(s) and/or measures) and the displayed box of the crosstab may indicate the new drill down level. The user may then reanalyze the visualized data and, if desired, drill down an additional level in the data.

In one example embodiment, the application of a box-in effect may result in all cells of the crosstab displaying numeric or tabular data. In one example embodiment, a user may apply a box-out effect to remove the added dimension(s) and/or measure(s) from the query and return one or more cells of the crosstab to the previous state. In one example embodiment, application of the box-out effect may result in all cells of the crosstab displaying numeric or tabular data. In one example embodiment, application of the box-out effect may result in all cells of the crosstab displaying the plot, graph, chart, numeric value, and/or tabular data that was displayed in the previous state of the crosstab.

### Example Lens Effect

In one example embodiment, a lens effect may be selected that allows a user to view data that may initially not be visible. In one example embodiment, four different lens effect techniques may be available that may be applied to a cell of a crosstab and may expose underlying data. In one example embodiment, a “correlation using high-low chart” lens effect can be applied which displays a high-low, or trending, chart for the corresponding data point in the crosstab. In one example embodiment, a “correlation using scatter plot” lens effect can be applied which displays a scatter plot for the corresponding data point in the crosstab in one example embodiment, a “correlation using multiple area chart” lens effect can be applied which displays a multiple area chart for the corresponding data point in the crosstab. In one example embodiment, a “correlation using parallel coordinates chart” lens effect can be applied which displays a parallel coordinates chart for the corresponding data point in the crosstab. In one example embodiment, the lens effect may be applied to a single cell and/or a plurality of cells without effecting the out-frame of the crosstab. For example, the lens effect may be applied to a single cell and/or a plurality of cells without effecting the parameters of the original query.

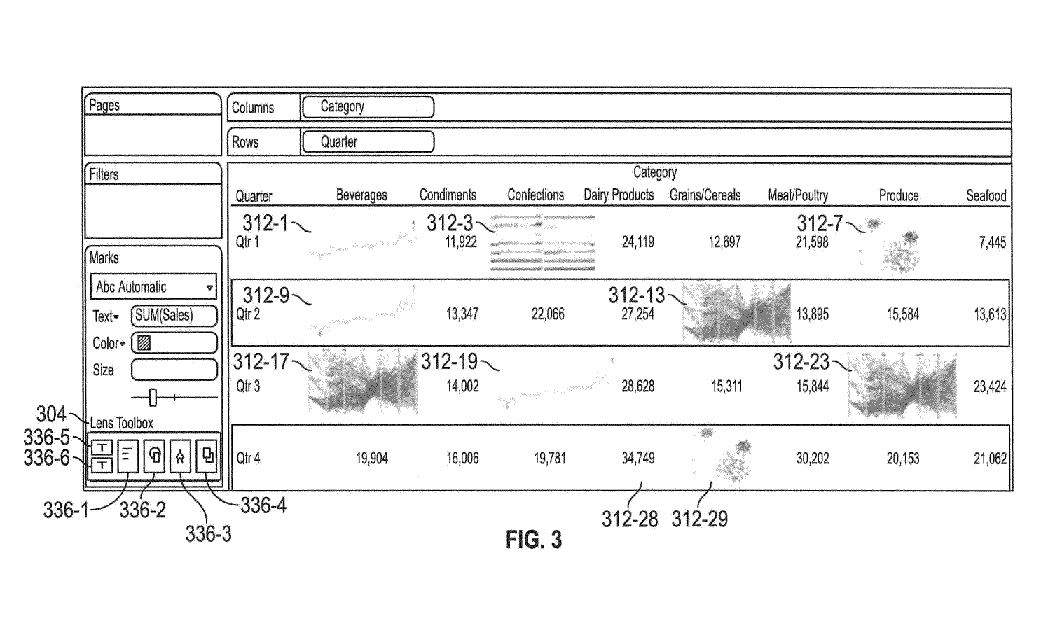

FIG. 3 is an example data visualization of a crosstab comprising an array of cells 312 based on an example underlying data configuration of 100 million rows and 100 columns, in accordance with one example embodiment. In one example embodiment, each cell (coordinate) in the table is a data point that can be expanded by applying a lens or brush effect. In the example of FIG. 3, a “correlation using high tow chart” lens effect has been applied to cells 312-1, 9, 19. In the example of FIG. 3, a multiple area chart lens effect has been applied to cell 312-3. In the example of FIG. 3, a “correlation using scatter plot” lens effect has been applied to cells 312-7, 29. In the example of FIG. 3, a “correlation using parallel coordinates chart” lens effect has been applied to cells 312-13, 17, 23.

In one example embodiment, a lens or brush technique may be implemented as a side-tool to enable a user to change the lens and/or brush effect while viewing the crosstab. In one example embodiment, a lens and/or brush side-tool enables a user to view data using a plurality of different lens and/or brush effects at the same time.

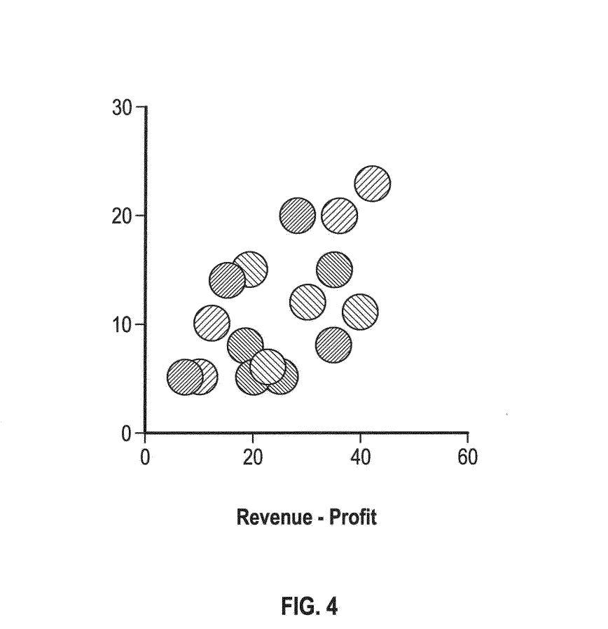

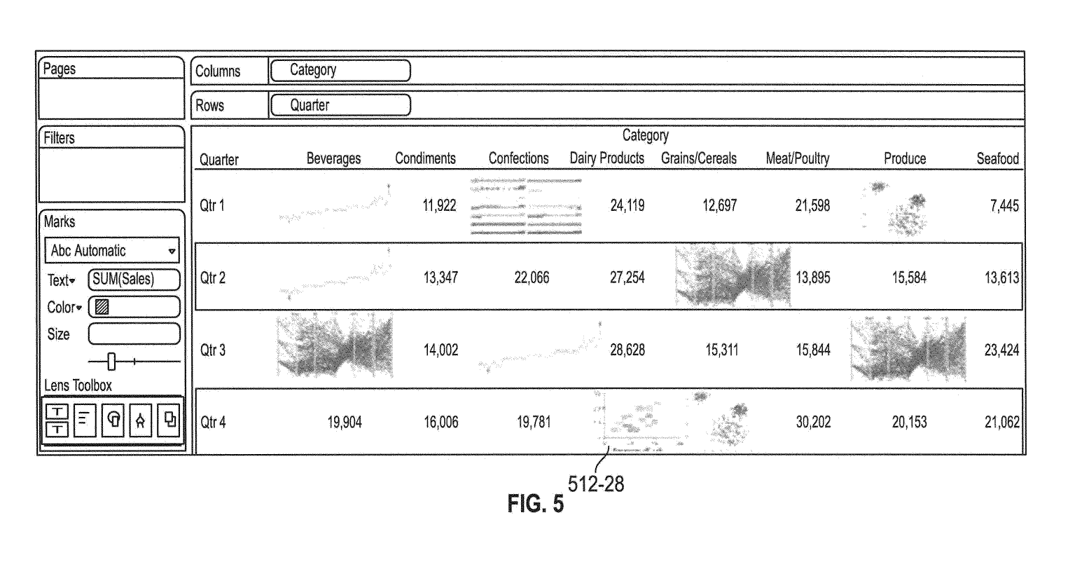

In one example embodiment a lens toolbox 304 may comprise four icons, each icon representing one of the four lens effects described above. A user may select one or more cells 312 and may select a lens effect 336 from the lens toolbox 304. For example, cell 312-28 and a “correlation using, scatter plot” lens effect 336-3 may be selected. A pop-up screen (not shown) will provide for the selection of the desired measures and dimensions. For example, a measure “sum (sales)+sum (profit)” and a dimension “country” may be selected. As a result, the scatter plot of FIG. 4 will be generated, where each color of the scatter plot may represent the sales for a particular country and the axes may represent the revenue and the profit. The lens effect may therefore expose a hidden dimension (“country”) and a hidden measure (”profit“). The lens effect may then be automatically applied to the selected cell and the data value of cell 312-28 of FIG. 3 may be replaced with the generated scatter plot. FIG. 5 illustrates the crosstab of FIG. 3 where the cell 312-28 has been replaced with the generated scatter plot chart.

### Box-In/Box-Out Method

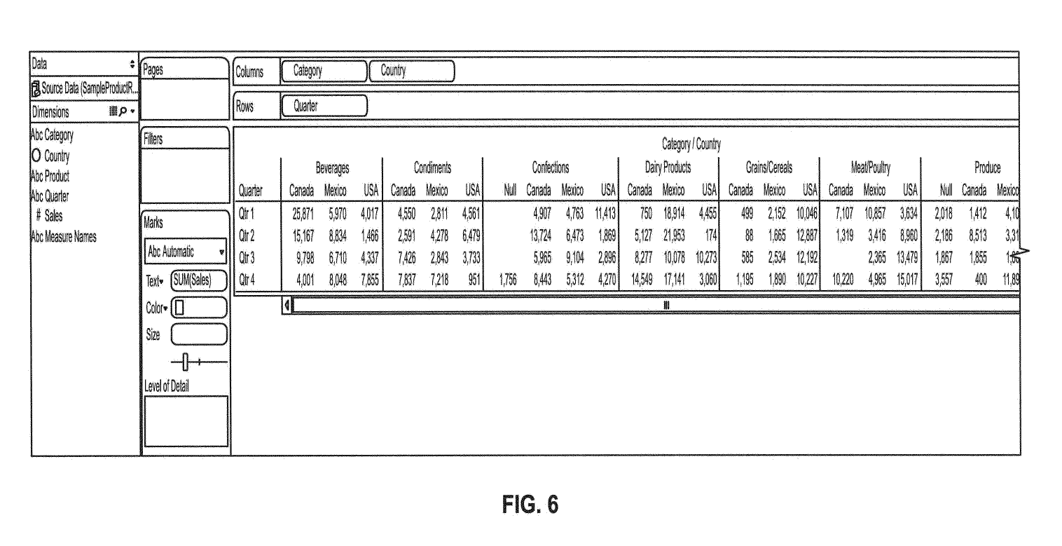

In one example embodiment, a user may “drill down”, or view details of the underlying data represented by a data point in a cell of the crosstab. For example, a user may choose to drill down on the scatter plot of cell 512-28. As described above, each color in the scatter plot chart of cell 512-28 represents the sales corresponding to a particular country. A user may therefore select to drill down along the dimension “country”. The user may select cell 512-28 and may select the box-in icon 336-5 in the lens toolbox 304. A pop-up screen (not shown) will provide for the selection of the desired dimension(s) and/or measure(s). As illustrated in FIG. 6, the scatter plot of cell 512-28 has been replaced with the number of dairy products sold during the fourth quarter for each of the applicable countries: Canada, Mexico and the United States.

In addition, as illustrated in. FIG. 6, the box-in technique may be selected to add a dimension to the query and/or expand a previously selected dimension, and thereby may effectively apply the effect to all cells of the crosstab. As a result, an added dimension may be “stacked” or merged with the initial crosstab. In FIG. 6, for example, the dimension “country” has been “stacked” on all columns of the crosstab.

In one example embodiment, a user may return one or more cells to their previous state by selecting the appropriate cell and the box-out icon 336-6 in the lens toolbox 304. In one example embodiment, returning a cell to its previous state using the box-out icon 336-6 may result in the numeric value corresponding to the previous state being displayed in the cell. In one example embodiment, returning a cell to its previous state using the box-out icon 336-6 may result in displaying in the cell the tabular data, plot, graph and/or chart which was displayed in the cell during the previous state. In one example embodiment, a user may return a query to its previous state by selecting the crosstab out-frame and the box-out icon 336-6 in the lens toolbox 304.

### Query Brush Effect

In one example embodiment, a query brush effect may be applied to the out-frame of a crosstab in order to apply the same effect to all cells of the crosstab. For example, a user may apply a “correlation using scatter plot” lens effect to a single cell and may recognize one or more relevant data patterns. The user may choose to apply the same effect that was applied to the single cell of the crosstab to the out-frame of the crosstab, thereby applying the same effect to all cells. In one example embodiment, application of a query brush effect to the out-frame of the crosstab applies a lens effect to all cells of the crosstab, and does not modify the query.

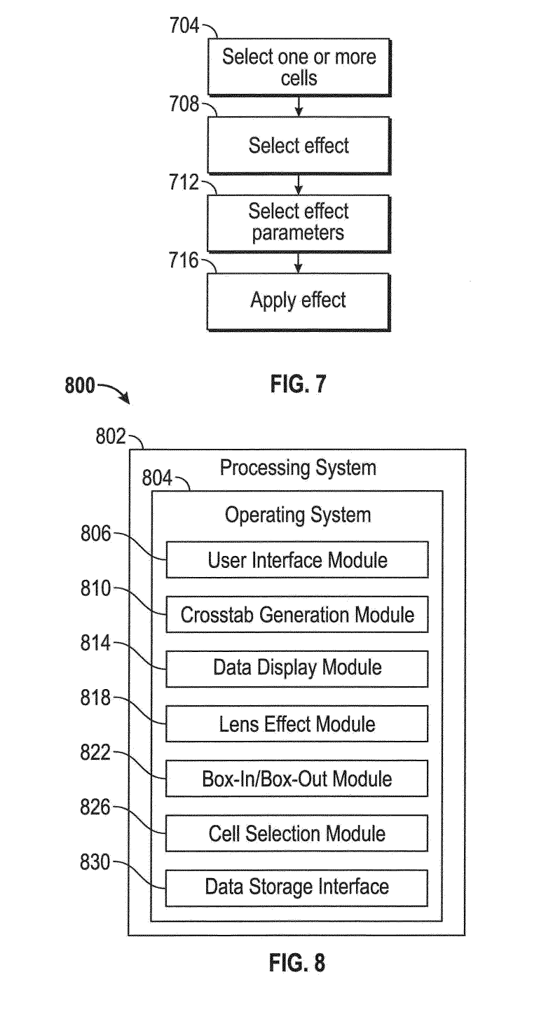

FIG. 7 is an example flowchart for applying a lens effect, a brush effect and/or a box-in/box-out effect to one or more cells of a crosstab, in accordance with one example embodiment. One or more cells of the crosstab may be selected (operation 704). The cell(s) are at the intersection of row(s) and column(s) and these row(s) and column(s) are included in the definition of a context. For example, cell 312-28 of FIG. 3 may be selected. A lens effect may be selected for application to the selected cell by selecting an icon 336 in the lens toolbox 304 (operation 708). For example, a “correlation using scatter plot” lens effect icon 336-3 may be selected to apply a scatter plot lens effect to selected cell 312-28. The effect may be an embedded query and may inherit the context of the selected one or more cells. That is, query parameters can be drawn from the context. The context can include the row(s) and column(s) of the selected cells, and the measure of the crosstab. However, further parameters may need to be defined. In response to the selection of a lens effect, a configuration screen may be displayed and the desired measures and dimensions may be selected (operation 712). In the example, a scatter plot exemplary selections of parameters may include, the measure “Sum (Sales)+Sum (Profit)” and the dimension “country” may be selected. The selected lens effect may be applied to the one or more selected cells (operation 716). For example, a scatter plot lens effect may be applied to selected cell 3-12-28, as depicted in FIG. 5. For example, the embedded query with the selected lens effect may be executed against a data source and the results may be returned. In accordance with an example embodiment, once applied to the selected one or more cells, the crosstab is updated. In other words, these results may be displayed.

FIG. 8 is a block diagram of an apparatus, in accordance with an example embodiment, for visually displaying data. For example, the apparatus 800 may be used to apply one or more lens effects, one or more brush effects and/or one or more box-in/box-out effects to data and, accordingly, is described by way of example with reference thereto.

The apparatus 800 is shown to include a processing system 802 that may be implemented on a server, client, or other processing device that includes an operating system 804 for executing software instructions. In accordance with an example embodiment, the apparatus 800 includes a user interface module 806, a crosstab generation module 810, a data display module 814, a lens/brush effect module 818, a box-in/box-out module 822, and a cell selection module 826. In accordance with an example embodiment, the apparatus 800 includes a data storage interface 830.

The user interface module 806 may present to a user a representation of a crosstab, and may allow a user to enter commands and parameters. For example, the user interface module 806 may enable a user to select a cell and a lens effect, and to enter parameters for the lens effect. The crosstab generation module 810 generates, for example, the data for the crosstab. The data display module 814 may render the crosstab for displaying, for example, on a computer screen. The lens/brush effect module 818 may, for example, apply a lens effect to one or more cells of the crosstab. The box-in/box-out module 822 may apply, for example, a box-in and/or box-out effect to the crosstab. The cell selection module 826 may enable the selection of one or more cells of the crosstab. For example, the cell selection module 826 may enable the selection of a plurality of cells for application of a brush effect,

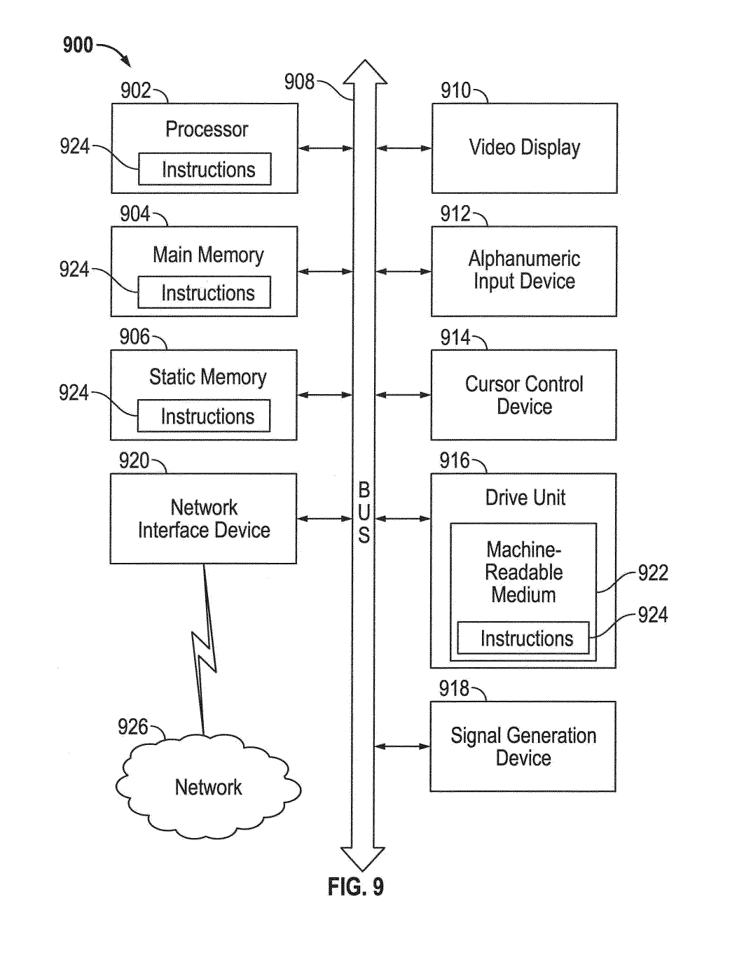

FIG. 9 is a block diagram of a computer processing system 900 within which a set of instructions, for causing the computer to perform any one or more of the methodologies discussed herein, may be executed. In some embodiments, the computer operates as a standalone device or may be connected (e.g., networked) to other computers. In a networked deployment, the computer may operate in the capacity of a server or a client computer in server-client network environment, or as a peer computer in a peer-to-peer (or distributed) network environment. In a networked deployment, the computer may operate in the capacity of a server or a client computer in a server-client network environment, or as a peer computer in a peer-to-peer (or distributed) network environment.

Embodiments may also, for example, be deployed by Software-as-a-Service (SaaS), Application Service Provider (ASP), or utility computing providers, in addition to being sold or licensed via traditional channels. The computer may be a server computer, a personal computer (PC), to tablet PC, a set-top box (STB), PDA, cellular telephone, or any processing device capable of executing a set of instructions (sequential or otherwise) that specify actions to be taken by that device. Further, while only a single computer is illustrated, the term “computer” shall also be taken to include any collection of computers that individually or jointly execute a set or multiple sets) of instructions to perform any one or more of the methodologies discussed herein.

The example computer processing system 900 includes processor 902 (e.g., a central processing unit (CPU), a graphics processing unit (GPU) both), main memory 904 and static memory 906, which communicate with each other via bus 908. The processing system 900 may further include video display unit 910 (e.g., a plasma display, a liquid crystal display (LCD) or a cathode ray tube (CRT)). The processing system 900 also includes alphanumeric input device 912 (e.g., a keyboard), a cursor control device 914 (e.g., a mouse, touch screen, or the like), a disk drive unit 916, a signal generation device 918 (e.g., a speaker), and a network interface device 920.

The disk drive unit 916 includes machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the processing system 900, the main memory 904 and the processor 902 also constituting computer-readable, tangible media.

The instructions 924 may further be transmitted or received over network 926 via a network interface device 920 utilizing any one of a number of well-known transfer protocols (e.g., Hypertext Transfer Protocol).

While the machine-readable medium 922 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the computer and that cause the computer to perform any one or more of the methodologies of the present application, or that is capable of storing, encoding or carrying data structures utilized by or associated with such a set of instructions. The term “computer-readable medium” shall accordingly be taken to include, but not be limited to, solid-state memories, and optical and magnetic media.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., the computing device) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and: or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmissions (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors 902 that are temporarily configured (e.g., by software) or permanently configured to perform the relevant operations. Whether temporarily or permanently configured, such processors 902 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processors may be located in a single location (e.g., within a home environment, an office environment, or as a server farm), while in other embodiments the processors may be distributed across a number of locations.

While the invention(s) is (are) described with reference to various implementations and exploitations, it will be understood that these embodiments are illustrative and that the scope of the invention(s) is not limited to them. In general, techniques for maintaining consistency between data structures may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventions). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the invention(s).

What is claimed is:

1. A method for displaying information in a crosstab, comprising:
selecting a subset of cells from a plurality of displayed cells in the crosstab, wherein the subset of cells has a context defined at least by one or more rows and one or more columns;
selecting an effect to apply on the subset of cells, wherein the effect includes an embedded query including parameters drawn from context of the subset of cells; and
applying an effect on the subset of cells.

2. The method of claim 1, wherein the effect is a lens effect parameterized by one or more of one or more measures and one or more dimensions.

3. The method of claim 1, wherein the effect results in one or more of exposing a hidden dimension, expanding an exposed dimension, and exposing a hidden measure.

4. The method of claim 1, wherein the lens effect is one of a correlation using high-low chart lens effect, a correlation using scatter plot lens effect, a correlation using cluster plot lens effect, a correlation using a multiple area chart lens effect, and a parallel coordinates lens effect.

5. The method of claim 1, wherein the effect is a brush effect and the corresponding effect is substantially simultaneously applied to two or more cells of the crosstab.

6. The method of claim 1, wherein the effect replaces a data point with one or more of tabular data, a plot, a chart and a graph.

7. The method of claim 1, wherein the effect is applied based on one or more of one or more conditions and one or more discriminations.

8. The method of claim 1, wherein the application applies a plurality of effects, each effect being applied to one or more cells of the crosstab independent of the application of other effects.

9. The method of claim 1, wherein the effect is a box-in effect that adds one or more of one or more dimensions and one or more measures to a query of the crosstab.

10. The method of claim 1, wherein the effect is a box-out effect that returns a query to a previous state.

11. The method of claim 1, wherein the effect is a box-out effect that returns a cell to a previous state and displays a numeric value corresponding to the previous state in the cell.

12. The method of claim 1, wherein the effect is a box-out effect that returns a cell to a previous state and displays one or more of tabular data, a plot, a graph, and a chart corresponding to the previous state.

13. The method of claim 1, wherein the effect is applied to all cells of the crosstab by applying a query brush effect to an out-frame of the crosstab.

14. An apparatus for displaying information in a crosstab, the apparatus comprising:
a processor;
memory to store instructions that, when executed by the processor cause the processor to:
select a subset of cells from a plurality of displayed cells in the crosstab, wherein the subset of cells has a context defined at least by one or more rows and one or more columns;
select an effect to apply on the subset of cells, wherein the effect includes an embedded query including parameters drawn from context of the subset of cells; and
apply an effect on the subset of cells.

15. The apparatus of claim 14, wherein the effect results in one or more of exposing a hidden dimension, expanding an exposed dimension, and exposing a hidden measure.

16. The apparatus of claim 14, wherein the application applies a plurality of effects, each effect being applied to one or more cells of the crosstab independent of the application of other effects.

17. The apparatus of claim 14, wherein the effect is a box-in effect that adds one or more of one or more dimensions and one or more measures to a query of the crosstab.

18. A computer-readable medium embodying instructions that, when executed by a processor perform operations comprising:
selecting a subset of cells from a plurality of displayed cells in the crosstab, wherein the subset of cells has a context defined at least by one or more rows and one or more columns;
selecting an effect to apply on the subset of cells. Wherein the effect includes an embedded query including parameters drawn from context of the subset of cells; and
applying an effect on the subset of cells.

19. The computer-readable medium of claim 18, wherein the application applies a plurality of effects, each effect being applied to one or more cells of the crosstab independent of the application of other effects.

20. The computer-readable medium of claim 18, wherein the effect is a box-in effect that adds one or more of one or more dimensions and one or more measures to a query of the crosstab.
